(19) United States
(12) Patent Application Publication
(10) Pub. No.: US 2005/0118439 A1
(43) Pub. Date: Jun. 2, 2005

(54) Metal coated film

(76) Inventor: Michael Jeschke, Wigton (GB)

Correspondence Address: WENDEROTH, LIND & PONACK, L.L.P., 2033 K STREET N. W., SUITE 800, WASHINGTON, DC, 20006-1021, US

(21) Appl. No.: 10/505,965

(22) PCT Filed: Feb. 24, 2003
(86) PCT No.: PCT/EP03/01855

(30) Foreign Application Priority Data
Feb. 28, 2002 (GB) 0204715.7

(51) Int. Cl. B32B 15/08; B32B 27/32; B32B 27/06

(52) U.S. Cl. 428/461; 428/521; 428/523; 428/910

(57) ABSTRACT

There is described a multi-layer oriented polyolefin film suitable for receiving a metal layer to form a high barrier thereon the film comprising a coat polymer layer at one surface, an metallizable polymer layer at the opposite surface and a core polymer layer sandwiched between and separating the coat layer and the metallizable layer where (a) the metallizable layer comprises at least one metallocene polypropylene (mPP); and/or (b) the core layer comprises at least 2% by weight (preferably at least 10%) of a hard resin preferably selected from at least one of: a dicyclopentadiene (DCPD) resin; a propylene-butylene copolymer and/or a hydrocarbon resin obtainable from C5 and/or C9 monomer(s). Preferably the film of the invention is metallized on at least one outer surface, more preferably directly onto the metallizable layer containing mPP.

The present invention relates to polymericfilms which are suitable for receiving a metal coat thereon and such films so metallised, as well as methods of preparing these films.

Polymeric films are often provided with a metal coat thereon as this is both aesthetically pleasing and also imparts a very high barrier to the film for gas and water transmission. It would be desirable to provide films which have an improved adhesion to such metal coatings so that the coating is substantially free of blemishes thereon and provides better barrier properties.

It is also desirable that such films are printable and heat sealable.

Certain films prepared from metallocene polypropylene (mPP) with a low molecular weight hydrocarbon resin (hard resin) are described in U.S. Pat. No. 6,165,599 (Demeuse). This document describes the type of metallocene catalysts that may be used to make mPP as used herein as well as described some of the hard resins that may also be used herein. The contents of this document are hereby incorporated by reference.

However Demeuse does not suggest that mPP and/or hard resin may be incorporated into BOPP multi-layer metallised films of the particular structure described herein in order to provide metal coated films having improved properties. Instead Demeuse teaches that these non-metallised films have improved optical properties. Demeuse neither suggests that the mPP coat be added to a surface layer to add metallisation nor that the hard resin in a core layer may also provide metallised films with improved properties.

Therefore broadly in accordance with the present invention there is provided a multi-layer oriented polyolefin film suitable for receiving a metal layer to form a high barrier thereon the film comprising a coat polymer layer at one surface, an metallisable polymer layer at the opposite surface and a core polymer layer sandwiched between and separating the coat layer and the metallisable layer characterised in that
(a) the metallisable layer comprises at least one metallocene polypropylene (mPP); and/or
(b) the core layer comprises at least 2% (preferably at least 10%) by weight of a hard resin.

Further aspects of the present invention provide for a film of the invention as described above coated with a metal coat on the metallisable layer and also a method of making such a metallised film comprising the step of coating a metallisable film as describe herein with metal coat on the metallisable layer.

Metallocene catalysts may comprise bridged bisdicyclopentadienyl or bisindenyl Group 4,5 or 6 transition metal dihalide derivatives. Specific metallocene catalysts known to be useful for producing polypropylene (mPP) are described in EP 0485820; EP 0485821, EP 0485822; EP 0485823, EP 0518092, EP 0519237, U.S. Pat. No. 5,145,819 and U.S. Pat. No. 5,296,434. Other references that discuss the metallocene catalysed process include EP 351,932, U.S. Pat. No. 5,055,438 U.S. Pat No. 5,234,800; U.S. Pat. No. 5,272,016; U.S. Pat. No. 5,272,236 and U.S. Pat No. 5,278,272. All of the cited documents are incorporated herein by reference.

Conveniently the hard resins incorporated in the core layer of the films of the present invention comprise a low molecular weight hydrocarbon resins which may be hydrogenated or unhydrogenated resins derived from olefin monomers. Examples of such resins comprise those derived from terpene monomers, coal tar fractions and petroleum feedstocks. Suitable resins include those prepared from terpene monomers (e.g., limonene, alpha and beta pinene, such as Piccolyte resins from Hercules Incorporated, Wilmington, Del., and Zonatac resins from Arizona Chemical Company, Panama City, Fla.). Other low molecular weight resins are prepared from hydrocarbon monomers and mixtures thereof, such as C₅ monomers (e.g., piperylene, cyclopentene, cyclopentadiene, and isoprene), oligomerized C₅ monomers, particularly the thermally oligomerized C_{0.5} monomers such as the hydrogenated thermally oligomerized cyclopentadiene resins sold under the trade name Escorez (for example Escorez 5300) by Exxon Chemical Co. of Baytown, Tex. Others are prepared from C₉ monomers, particularly the monomers derived from C_{0.9} petroleum fractions which are mixtures of aromatics, including styrene, methyl styrene, alpha methyl styrene, vinyl naphthalene, the indenes and methyl indenes and, additionally, pure aromatic monomers, including styrene, .alpha.-methyl-styrene and vinyltoluene. Examples of these resins include hydrogenated .alpha.-methyl styrene-vinyl toluene resins sold under the trade name Regalrez by Hercules Incorporated of Wilmington, Del. The hydrogenated C₉ and pure monomer resins are preferred. Particularly preferred are the hydrogenated cyclopentadiene resins and the hydrogenated aromatic resins derived from pure aromatic monomers, e.g., the hydrogenated.alpha.-methyl styrene-vinyltoluene copolymers.

More preferred hard resins are selected from at least one of: a dicyclopentadiene (DCPD) resin; a propylene-butylene copolymer and/or a hydrocarbon resin obtainable from C₅ and/or C₉ monomer(s).

Preferably the film of the invention is metallised on at least one outer surface more, more preferably directly on the metallisable layer which optionally may first be conventionally treated by any suitable means (e.g. by corona discharge).

Without wishing to be bound by any mechanism it is believed that the improved barrier properties of metallised films of the invention arise because of the smooth surface for metallisation resulting from the use as the metallisable layer the highly regularly crystalline mPP. Alternatively or as well it is believed the addition of hard resin to the core layer increases the barrier of that layer to penetration therethrough should any species be able to penetrate any imperfections (pin hole defects etc) in the metal surface coat.

Further aspects and preferred features of the invention are given in the claims.

The invention will now be illustrated by reference to the following non-limiting examples

All the films described herein were made as follows.

A three layer polymeric tube was formed by coextruding through an annular nozzle three polymer streams, a core layer A of polypropylene (referred to herein as PP) homopolymer; an outer layer B of one coat polymer on the outside of the tube; and an inner layer C of another coat polymer on inside of the tube. The extruded tube so formed comprises a three layer film with layers A B C from the outer to inner surface. The tube was cooled and subsequently re-heated before being blown into a bubble to orient the film. A film web was obtained (without collapsing the bubble onto itself) to form as the resultant film an un-laminated three layer biaxially oriented PP (BOPP) film having a layer structure A B C i.e. where there is a coat layer A at one surface of the BOPP film (corresponding to the outside of the bubble) and a metallisable layer C at the other film surface (corresponding to the inside of the bubble) with a core polymer layer B sandwiched between the these two layers A and C.

Typically the final film may be about 15 microns thickness on average with for example the coat layer “A” being about 0.3 micron thick, the core layer “B” being about 14 μm thick and the metallisable layer “C” being about 0.6 micron thick.

As used herein the term “metallocene” polypropylene (hereinafter mPP) refers to PP made using a metallocene complex as the polymerisation catalyst. Such catalysts produce PP in which the tacity of the polymer chain is more readily controlled leading to a more highly ordered polymer of more regular structure and controlled molecular weight. Thus mPP is more crystalline that conventional PP produced using a Zeiger Nata catalyst. It will be appreciated that the mPP used in the invention could be substituted with any other PP of similar properties prepared by any other suitable process which is a selective as that for mPP.

For the three layer non-laminate BOPP films tested herein each layer was constructed as follows:

Comp I and Comp II—Base Film—Inner and Core Unmodified

Comp I and Comp II were different batches of the same film of:

Coat layer “A” comprises an ethylene-propylene random copolymer with 1000 ppm of a conventional silica anti-block agent plus polyformaldehyde beads in polypropylene as an non-migratory slip agent (such as those available under the trade name ABVT 19) Core layer “B” comprises a PP nucleated homopolymer plus 400 ppm sodium benzoate Metallisable layer “C” was the same as the coat layer “A”

### EXAMPLES 1i AND 1ii

### mPP (Inner)

Examples 1i and 1ii were modified versions of Comp I and II respectively where the metallisable layer “C” comprised a mPP coat polymer plus 1200 ppm of a silica anti-block agent.

### EXAMPLES 1i AND 1ii

### mPP (Inner)+Hard Resin (Core)

Examples 2i and 2ii were modified versions of Examples 1i and 1ii respectively where the core layer “B” additionally comprised 10% w/w of a dicylcopentadiene (DCPD) hard resin

### EXAMPLES 3i AND 3ii

### Modified (Inner)

Examples 3i and 3ii were modified versions of Comp I and II respectively where the metallisable layer “C” comprised a propylene-butylene random copolymer plus 1000 ppm of a silica anti-block agent.

### EXAMPLES 4i AND 4ii

### Modified (Inner)+Hard Resin (Core)

Examples 4i and 4ii were modified versions of Examples 3i and 3ii respectively where the core layer “B” additionally comprised 10% w/w of a dicylcopentadiene (DCPD) hard resin

Film Sample Testing

All samples tested in the evaluation were approximately 30 microns in thickness.

Results

Barrier and optical property testing on un-metallised film

| | WVTR | | | |
|---|---|---|---|---|
| Sample | 38° C./90% RH | OTR 23° C./0% RH | | |
| (%) | g/m²/24 hours | cm³/m²/24 hours | NAH (%) | WAH |
| Comp I | 5.2 | 1975 | 0-2 | 1.4 |
| Comp II | 5.2 | 1873 | 0-3 | 2.1 |
| Ex 1i | 5.6 | 1919 | 0-3 | 1.6 |
| Ex 1ii | 5.9 | 1782 | 0-2 | 1.5 |
| Ex 2i | 3.2 | 861 | 0-3 | 1.9 |
| Ex 2ii | 3.4 | 894 | 0-2 | 2.4 |
| Ex 3i | — | — | — | — |
| Ex 3ii | — | — | — | — |
| Ex 4i | 3.4 | 933 | 1-3 | 1.3 |
| Ex 4ii | 3.3 | 618 | 0-3 | 1.5 |

Adhesion to the discharged treated (metallisable) film surface - layer C

| | Print Adhesion | Metal adhesion |
|---|---|---|
| Sample | DT (% pull off) | DT (% pull off) |
| Comp I | 0% | 0% |
| Comp II | 0% | 0% |
| Ex 1i | 0% | 0% |
| Ex 1ii | 0% | 0% |
| Ex 2i | 0% | 0% |
| Ex 2ii | 0% | 0% |
| Ex 3i | — | — |
| Ex 3ii | — | — |
| Ex 4i | 0% | 0% |
| Ex 4ii | 0% | 0% |

The lower the % pull off the better the print/metal adhesion.

Mechanical property testing

| Sample | YM MD | YM TD | TS MD | TS TD | EAB MD | EAB TD |
|---|---|---|---|---|---|---|
| Comp I | 1856 | 2853 | 150 | 194 | 101.8 | 64.6 |
| Comp II | 2283 | 2675 | 161 | 180 | 112.4 | 65.6 |
| Ex 1i | — | — | — | — | — | — |
| Ex 1ii | — | — | — | — | — | — |
| Ex 2i | 3462 | 3734 | 139 | 189 | 95.2 | 69.5 |
| Ex 2ii | 3076 | 3424 | 165 | 192 | 121.8 | 75.4 |
| Ex 3i | — | — | — | — | — | — |
| Ex 3ii | — | — | — | — | — | — |
| Ex 4i | 2366 | 3689 | 141 | 208 | 108.7 | 71.2 |
| Ex 4ii | 3753 | 3633 | 162 | 203 | 122.9 | 68.6 |

YM = Young's modulus (MPa)
TS = Tensile strength (MPa)
EAB = Elongation at break (%)

Coefficient of friction analysis of examples at 23° C.

| Sample | In/In | In/Out | Out/Out | In/Metal | Out/Metal |
|---|---|---|---|---|---|
| Comp I Static | 0.54 | 0.45 | 0.44 | 0.43 | 0.35 |
| Comp I Dynamic | 0.42 | 0.41 | 0.38 | 0.38 | 0.31 |
| Comp II - Static | 0.75 | 0.60 | 0.52 | 0.52 | 0.32 |
| Comp II - Dynamic | 0.56 | 0.50 | 0.44 | 0.35 | 0.27 |
| Ex 1i - Static | 0.27 | 0.29 | 0.32 | 0.15 | 0.14 |
| Ex 1ii - Dynamic | 0.22 | 0.23 | 0.24 | 0.13 | 0.12 |
| EX 2i - Static | 0.34 | 0.30 | 0.28 | 0.22 | 0.16 |
| Ex 2ii - Dynamic | 0.29 | 0.25 | 0.20 | 0.16 | 0.11 |
| Ex 3i - Static | 0.54 | 0.53 | 0.45 | 0.37 | 0.39 |
| Ex 3ii - Dynamic | 0.49 | 0.44 | 0.42 | 0.33 | 0.38 |
| Ex 4i - Static | 0.52 | 0.51 | 0.43 | 0.32 | 0.22 |
| Ex 4ii - Dynamic | 0.42 | 0.40 | 0.38 | 0.23 | 0.19 |

Slip properties of the film having a Metallocene polypropylene polymer as the metallisable layer C (Examples 1 and 2) with or without hard resin in the core polymer—layer B—are much lower than the values for base film Comp I and II. Slip properties of the propylene-butylene metallisable grade polymer as layer C with hard resin in the core polymer layer B (Example 4) are similar to the values for base film Comp I and II.

Metallised Sample Properties.

Metallised film barrier properties have been compared with a standard base film Comp I and II.

and a film grade using propylene-butylene copolymer on the corona treated metallisable side of the film=layer C (Examples 3 and 4).

| Sample | Print Adhesion | WVTR at 38° C./90% RH | OTR at 23° C./ |
|---|---|---|---|
| 0% RH | DT (% pull off) | g/m²/24 hours | cm³/m²/24 hours |
| Comp I | 5% | 0.81 | 88 |
| Comp II | 0% | 0.98 | 136 |
| Ex 1i | 0% | 0.79 | 43 |
| Ex 1ii | 0% | 0.46 | 51 |
| Ex 2i | 0% | 0.33 | 32 |
| Ex 2ii | 0% | 0.43 | 31 |
| Ex 3i | 0% | 0.32 | 35 |
| Ex 3ii | 0% | 0.36 | 68 |
| Ex 4i | 0% | 0.31 | 36 |
| Ex 4ii | 5% | 0.34 | 30 |

Conclusions

The results presented above have shown that using metallocene polypropylene as the metallisable layer C with hard resin in the core polymer (layer B) gives beneficial effects over metallisation onto the surface of a conventional BOPP film having a conventional coat polymer layer. The water vapour and oxygen barrier properties both decrease with the new polymer as layer C with no print adhesion loss. The hard resin used as the core polymer additive (in layer B) is preferably of the dicyclopentadiene (DCPD) type.

Oxygen and water vapour barrier properties are improved with metallocene polypropylene as the metallisable surface (layer C) and optical properties are similar when metallocene polypropylene is used as layer C. The metallocene polypropylene does not affect printability or metal adhesion on the corona treated surface.

When using the propylene-butylene coat polymer as layer C with hard resin in the core polymer (layer B) similar benefits are seen when compared to use of metallocene polypropylene as the polymer for layer C.

The use of metallocene polypropylene as a polymer to provide a metallisable film surface gives major benefits with respect to barrier properties over conventional polymers (such as Zeiger Nata PP) currently used to provide metallisable surfaces. Yet optical properties of the films of the invention are comparable to those of conventional films. Metallisation of the new film was possible with no detrimental effects on the print adhesion.

The metallocene polypropylene as the metallisable surface (layer C) could be used to produce a very high barrier metallisable film and it can be seen that the metallised film barrier can be increased even further by the addition of hard resin in the core polymer (layer B).

1. A multi-layer oriented polyolefin film suitable for receiving a metal layer to form a high barrier thereon the film comprising a coat polymer layer at one surface, a metallizable polymer layer at the opposite surface and a core polymer layer sandwiched between and separating the coat layer and the metallizable layer wherein:
(a) the metallizable layer comprises at least one metallocene polypropylene (mPP); and/or
(b) the core layer comprises at least 2% by weight of a hard resin.

2. The multi-layer film as claimed in claim 1, which comprises both (a) the metallizable layer comprising mPP and (b) the core layer comprising hard resin.

3. The multi-layer film as claimed in claim 1, in which the core layer comprises at least 10% by weight of hard resin.

4. The multi-layer film as claimed in claim 1, in which the hard resin is selected from at least one of: a dicyclopentadiene (DCPD) resin; a propylene-butylene copolymer and/or a hydrocarbon resin obtainable from C₅ and/or C₉ monomer(s).

5. The multi-layer film as claimed in claim 4, in which the hard resin comprises DCPD.

6. The multi-layer film as claimed in claim 1, which further comprises a metal coat on either surface.

7. The multi-layer film as claimed in claim 6, which further comprises a metal coat applied directly onto the metallizable layer.

8. The multi-layer film as claimed in claim 7, in which the metallizable layer is pretreated to enhanced adhesion of the metal coat before application thereof.

9. The multi-layer film as claimed in claim 8, in which the pre-treatment is a corona discharge.

10. (canceled)
